(19) United States
(12) Patent Application Publication
(10) Pub. No.: US 2016/0197943 A1
(43) Pub. Date: Jul. 7, 2016

(54) System and Method for Profiling System Attacker

(71) Applicant: Leviathan, Inc., Seattle, WA (US)

(72) Inventors: Falcon Momot, Seattle, WA (US); Mikhail Davidov, Seattle, WA (US)

(73) Assignee: LEVIATHAN, INC., Seattle, WA (US)

(21) Appl. No.: 14/749,442

(22) Filed: Jun. 24, 2015

Related U.S. Application Data
(60) Provisional application No. 62/016,166, filed on Jun. 24, 2014.

(51) Int. Cl. H04L 29/06

(52) U.S. Cl. CPC H04L 63/1416; H04L 63/1433

(57) ABSTRACT

Systems, methods and media are shown for generating a profile score for an attacker involving a detection unit configured to identify one or more malicious code elements in a payload, a weighting unit configured to associate a weighting value with each identified malicious code element, and a classification unit configured to sum the weighting values associated with the identified malicious code elements and associate a classification with the attacker based on scored based the weighting values. Some examples also involve applying a model to weighting values for identified malicious code elements that may include a Markov model, a model based on apparent skill, a model based on resourcing required by the malicious code, or a model based on behavior patterns

### CROSS REFERENCE TO RELATED APPLICATIONS

This application claims the benefit of U.S. Provisional Patent Appl. No. 62/016,166 for “System and Method for Profiling System Attacker” filed Jun. 24, 2014, herein incorporated by reference in its entirety for all purposes.

### GOVERNMENT LICENSE RIGHTS

This invention was made with government support under FA8750-12-C-0161 awarded by the Air Force. The government has certain rights in this invention.

### BACKGROUND

Computer networks and the devices and services that reside on them are often the subject of attacks by parties that are attempting to improperly access information and resources or to introduce malicious code to the networks. The attackers who are threats to information technology infrastructure assets and to the confidentiality of information stored in them may come from a wide variety of different sources, with different motives, levels of sophistication, available resources, and expertise.

### SUMMARY

According to one aspect of the present invention, a system for generating a profile score for an attacker includes a detection unit configured to identify one or more malicious code elements in a payload, a weighting unit configured to associate a weighting value with each identified malicious code element; and a classification unit configured to sum the weighting values associated with the identified malicious code elements and associate a classification with the attacker based on the sum of the weighting values.

### BRIEF DESCRIPTION OF THE DRAWINGS

Various embodiments in accordance with the present disclosure will be described with reference to the drawings, in which:

FIG. 1 is a schematic diagram depicting an example of a computer network based system that may be subject to attack and may be suitable for utilization of certain aspects of the present invention;

FIG. 2 is a functional block diagram illustrating an example of an attacker profiling system in accordance with certain aspects of the present invention;

FIG. 3 is a schematic diagram illustrating the scoring of a malicious code payload in accordance with certain aspects of the invention;

FIG. 4 is a control flow diagram illustrating an example of a method for profiling an attacker in accordance with certain aspects of the invention; and

FIG. 5 depicts aspects of elements that may be present in a computer device and/or system configured to implement a method, system and/or process in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Examples of methods and systems are shown for developing a profile for an attacking entity in order to predict future behaviour and assess the type and level of response required. The method involves discerning, for example, a level of expertise and sophistication, and to a certain extent the available resources, of an attacker from available information (e.g. forensic logs). Expertise, sophistication, and resources may be inferred from data regarding the techniques used by a particular threat, such as the difficulty of use of the attack techniques as well as whether or not they are publicly known or made simpler by the manner in which they are distributed to the public.

Attacking entities are identified behaviorally. One approach is to create a Markov model of the attacker's usage of techniques. Another approach, which is generally simpler and faster, is to profile the attacker according to how much apparent skill or resourcing they have. These approaches do not require specifically identifiable information regarding the attacker. Instead, the behavior pattern is used to identify or classify an attacker.

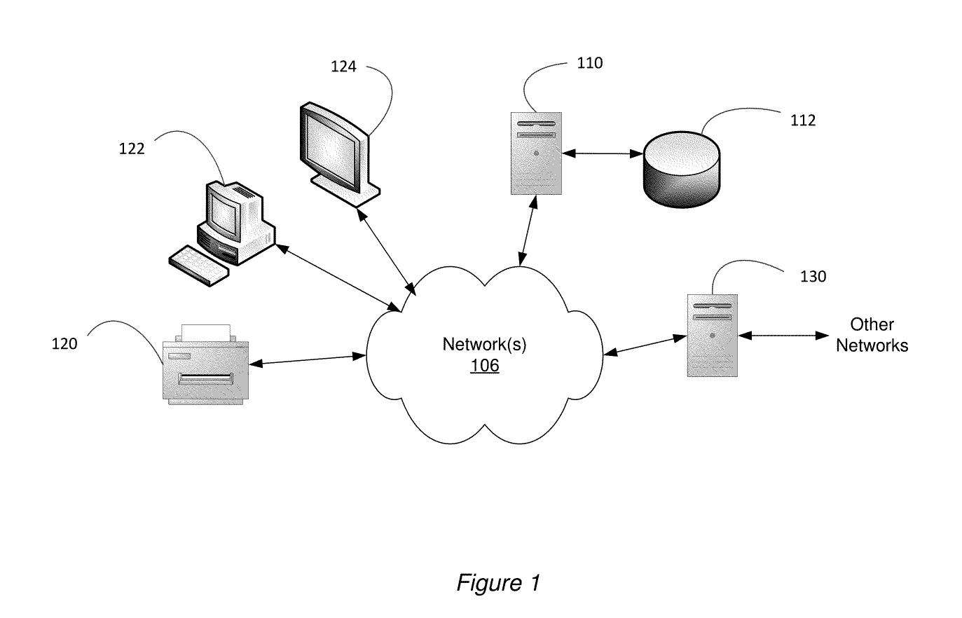

FIG. 1 is an architecture diagram that depicts aspects of an example of a computer network system with communication among multiple devices. In this example, network 106, which can be one network or multiple networks, provides communication between server 110 connected to database 112 and several client devices, such as printer 120, personal computer 122, and interactive terminal 124. The architecture of FIG. 1 is a simplified representation of an enterprise environment having a multitude of different computing devices that may represent a target for an attack. A gateway 130 provides a communications link between the network 106 and other networks, such as the internet, through which an attacker may launch an attack.

In one example, a method or system having an additive model can be used to quantify the complexity of an attacker's payload and thus determine the level of threat they present to information security. Such a system is comprised of three discrete components: a detector, which provides a list of techniques that were used on a system, a modeller that combines this information, and a quantizer that evaluates it against a series of thresholds.

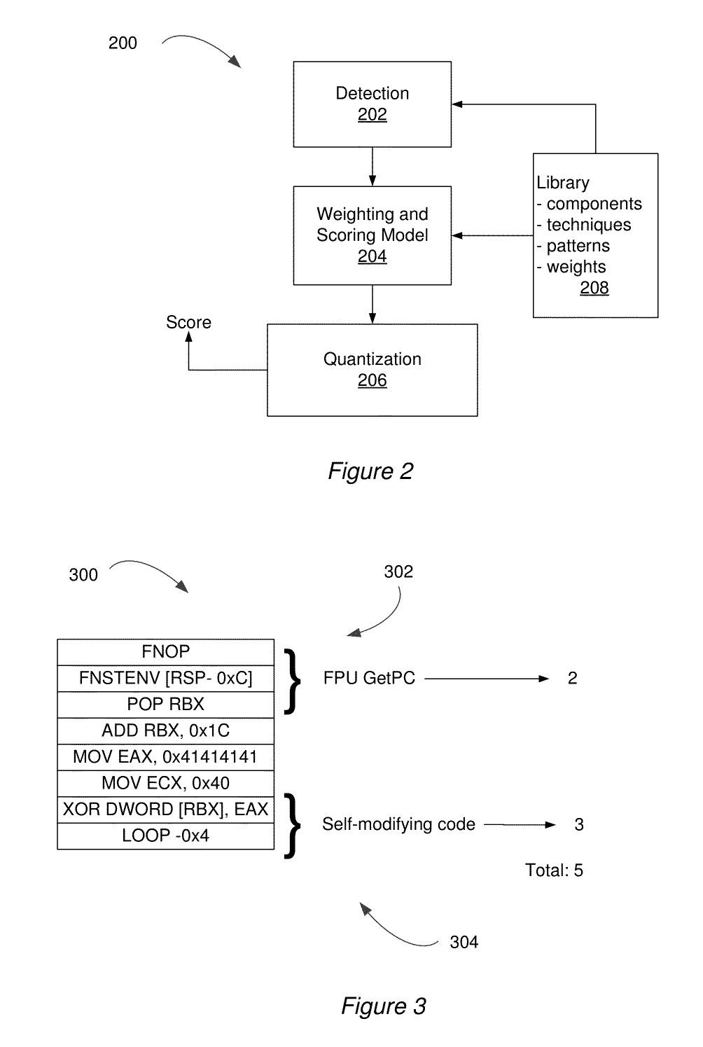

FIG. 2 is a functional block diagram illustrating one example of an additive model 200. The exploit element detection component 202 may be a common feature of instrumented emulators used in malware analysis. Components are discrete procedures which give rise to suspicion when seen in combination with other such procedures. FIG. 3 is a schematic diagram illustrating one example of a code trace 300 illustrating an example of the scoring of a code payload used in an attack based upon code components utilized in the attack. Code trace 300 includes a series of instructions or code components from, for example, an emulator, a code dump or a forensic log file that contains two malicious components indicative of an attack: an FPU GetPC 302 and a decoder loop 304. In this example, an instrumented emulator or static analysis tool has identified and classified the malicious components and output indicators.

At block 304 of FIG. 2, the malicious component indicators are mapped to weights and the weights are summed. The weights may be determined according to the complexity of integrating a malicious component into a functional payload. Neither the FPU GetPC 302 nor decoder loop 304 components of the elements in FIG. 3 are complex to use, and, in this example, the weights based on complexity are relatively low. However, the components example are also not typically associated with a low-skill attacker, and so they are assigned positive weight values rather than negative values. In this example, FPU GetPC 302 has a weighted value of 2 and decoder loop 304 has a weighted value of 3. Weighting values for identifiable malicious components may be maintained, for example, in a table or database accessible to weighting block 204 of FIG. 2 and may be predetermined or dynamically assigned based on, for example, the extent to which an attack primitive contributes to platform or location independence of the code, the orthogonality of the code (higher orthogonality, higher complexity score), or how commonly they are utilized in an attack (more commonly used, lower score). The sum of the two low-complexity components 302 and 304 remains a low weighting, e.g. 5, so the code in this example of an attack would be classified as a novice payload. However, payload complexity increases proportionally with the number of components utilized, so if more components were involved, e.g. perhaps 5 simple components, quantizer 206 may quantize on a higher boundary, i.e. examine a larger amount of code, and the skill classification would be greater.

Note that the scoring weight of a component or element can also be negative, indicating that some element is a unsophisticated, well known or weak component, i.e. a “crutch”, typically used by less-skilled attackers. Such an element is typically one which is widely understood to add undesirable preconditions to exploit code or increase the ease with which the exploit can be detected or mitigated.

In one approach, weights are assigned statically, such as through a table or database, where, for example, an index value based on the type of exploit or a signature of the exploit are used to index the table to obtain the corresponding weight value. The weights in the table may be revised over time, e.g. as an exploit becomes more widely known, its use may receive a lower weight value. Alternatively, a table may be modifiable by, for example, a system administrator to provide for a customized weighting. In another alternative, different weighting tables that are specific to the type of target system, e.g. a mail server versus a financial information server or a website, may be used to provide attacker profiling that is weighted according to the particular vulnerabilities of the targeted system type. Still another approach involves assigning weighting values on a normal distribution or bell curve basis.

In one example, modeller 200 of FIG. 2 considers the presence or absence of some element of an attack to be boolean, i.e. contributing the weight assigned to the element to a total to the score for a payload just once if the component is present one or more times. It then evaluates the weight score against multiple thresholds, in order of greatest to least. The first threshold which the total falls on or beneath is the skill level score attributed to the attacker. Levels are pinned to a floor of 0 since values lower than this are not meaningful.

The number of techniques used is typically related to the number of techniques available in the attacker's library, and so may positively correlate with the skill of the attacker and thus the level of threat that they pose to information security. The types of techniques used can be used to infer the level of knowledge the attacker has about the program under attack, and about exploitation in general. For example, an attacker who uses a pre-packaged and publicly-available exploit payload, which is likely already identified as malicious code and readily detected by security applications, probably has less resources and skill than one who uses a custom-built payload. A custom-built payload is more difficult to detect, because the same code sequence has probably not been used in an attack, and, therefore, is a more significant threat. Thus, the attacker who was able to create their own payload is also a greater threat. Further, techniques that offer benefits only when combined with many other techniques, or which are technically difficult and go beyond the minimum requirements of a payload, also typically indicate greater skill and are weighted more heavily. Another example of a highly weighted attack is a payload that detects and protects against debugging in order to better hide itself because this technique demonstrates insight and expertise on the part of the attacker. Other examples of highly weighted attacks include those that exploit features of the system under attack whose workings are not widely understood, e.g. attempts to exploit cache incoherence in a processor, which are generally highly involved and require a detailed understanding of the underlying architecture, and indicate a stronger level of skill on the part of the attacker. Less sophisticated attack techniques are readily collected in a table or database. More complex attacks may require more complicated analysis to identify them.

The attacker profile may be provided in an alert or a report regarding an attack, such as in an email to a system administrator for the targeted system. The alert or report may include the classification, e.g. “expert” or “novice”. A user interface may also be provided that displays the attacker classification alongside or nearby a crashdump result set. A generalized threat indication may be displayed by the user interface that indicates what type of attackers are currently attacking the user's system in aggregate.

The classification of techniques in this example is highly dynamic and often dependent on nontechnical factors, such as the published body of malicious code and techniques, and thus the classification itself is preferably configurable.

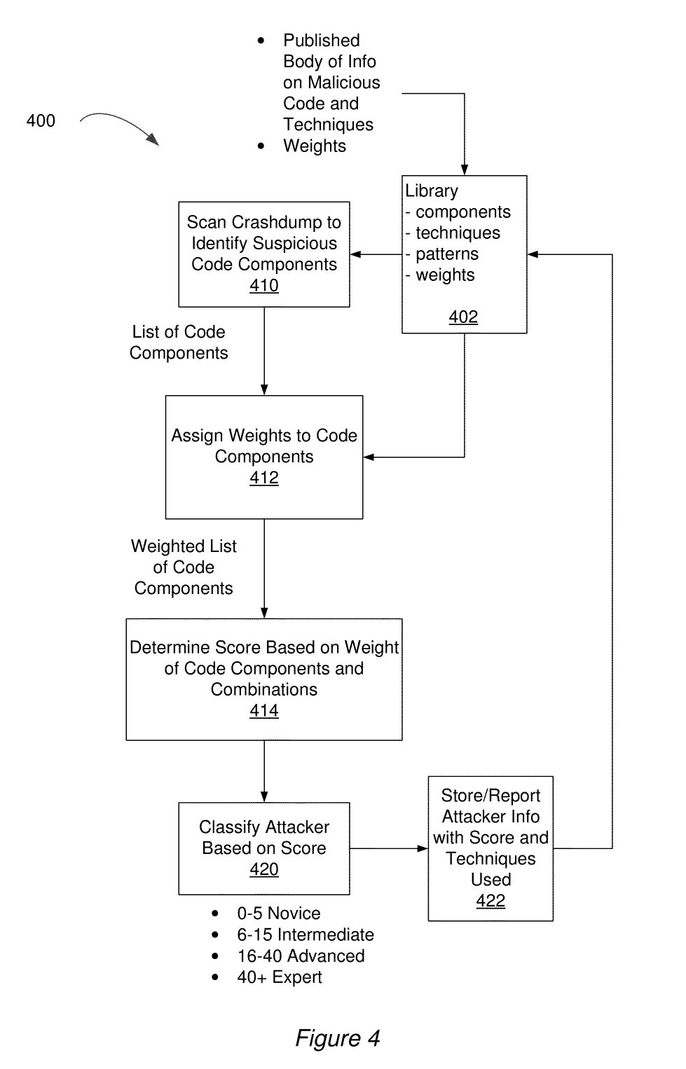

FIG. 4 is a control flow diagram illustrating an example of a method 400 for profiling a system attacker. In this example, a library 402 contains information regarding the components, techniques and patterns used by system attackers. This information may be obtained from published bodies of information on malicious code and techniques, which are maintained and distributed by a variety of industry sources. In the present example, weights are assigned to the components, techniques and patterns based on their complexity, commonality of usage, and other factors. At step 410, a Crashdump, in this example, is scanned to identify suspicious code components utilizing information from library 402 and a list of potentially malicious code components is generated. At step 412, a model is applied to the list of code components to assign weight values from library 402 to the list of components to produce a weighted list of potentially malicious code components. The weighted list is analyzed at step 414 to determine a score for the crashdump based on the number and weight of the suspicious code components in the list and, in some embodiments, additional scoring may be determined based on the combination of techniques used, e.g. a combination of techniques that illustrates a high degree of sophistication. At step 420, the attacker corresponding to the crashdump is classified based on the score. For example, a score of 5 or less may be classified as Novice, 6-15 as Intermediate, 16-40 as Advanced, and over 40 as Expert. At step 422, information regarding the attacker, the characteristics of the attack, e.g. the techniques and combinations used, and the score and classification are stored, e.g. in library 402, and may also be reported or used to generate an alert.

Embodiments of the weighting and classification techniques of the present invention may include a variety of aspects. In one aspect, an existing framework that performs another task, such as emulating a computer system or analyzing memory dumps for unusual data, may be utilized to passively report on which specific techniques likely resulted in an observed scenario. Another aspect involves aggregating data gathered on specific techniques that appear to have been used in exploitation together, on a weighted sum or weighted average basis, to produce a continuous scalar variable indicating the relative level of sophistication that an attacker appears to possess. Still another aspect involves the use of a library of identifying information on specific techniques, such as a payload signature database similar to an antivirus database, however queried, to ascertain whether a technique that is observed is novel, a novel application of an existing known technique, or a packaged and publicly distributed application of an existing known technique.

Still another aspect is using a negative weight to indicate a technique that is typically avoided by skilled attackers, such as a well-known exploit, that is typically only used by unskilled or low-threat attackers. Yet another aspect is the accretion of data identifying an exploitation technique, whether automatic or operator-assisted, in order to identify an actor or family of similar actors who are using that technique in some activity related to a computer system. Another aspect is quantization of a scalar variable indicating attacker skill as a method for classifying an attacker, as to whether they represent an advanced threat or a casual or opportunistic attacker.

In accordance with at least one embodiment of the invention, the system, apparatus, methods, processes and/or operations described herein may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system. In accordance with another embodiment of the invention, the system, apparatus, methods, processes and/or operations described herein may be wholly or partially implemented in the form of a set of processor executable instructions stored on persistent storage media.

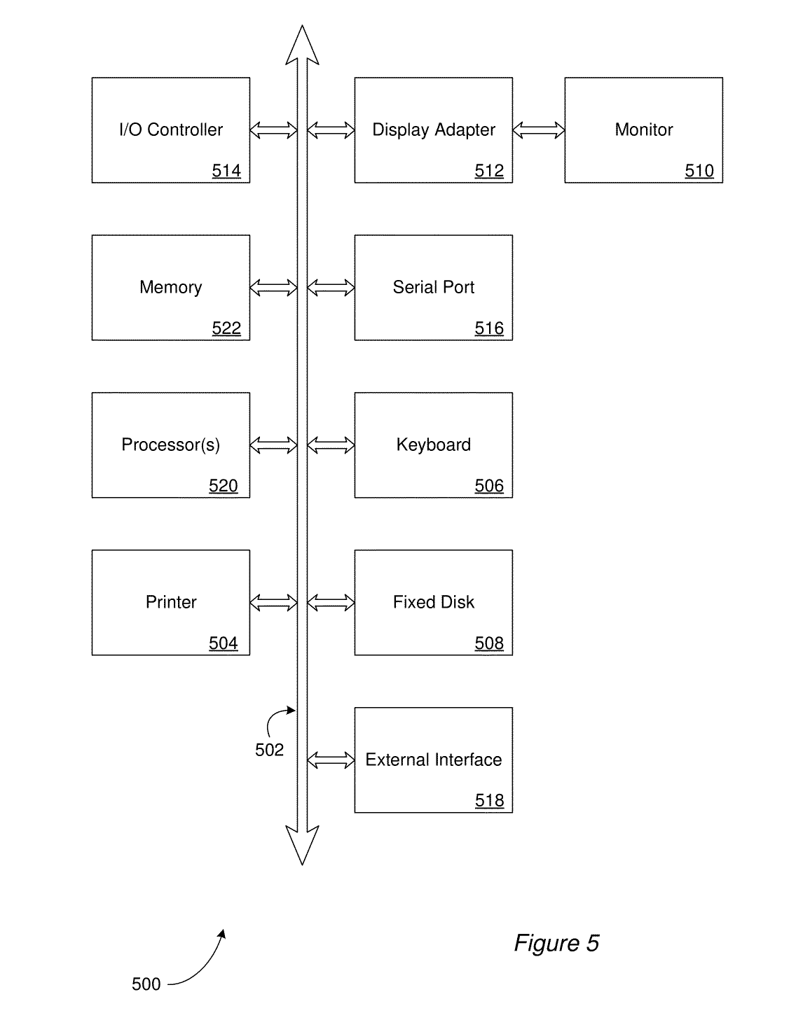

FIG. 5 depicts aspects of elements that may be present in one example of a computer device and/or system 500 configured to implement at least some elements of a method, system and/or process in accordance with some embodiments of the present invention. The subsystems shown in FIG. 5 are interconnected via a system bus 502. Additional subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 4 including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl or using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM, where the code is persistently stored sufficient for a processing device to access and execute the code at least once. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components or steps depicted in the drawings or described above, as well as components and steps not shown or described, are possible without departing from the scope of the invention. Similarly, some features and subcombinations are useful and may be employed without reference to other features and subcombinations. Embodiments of the invention have been described for illustrative and not restrictive purposes, and alternative embodiments will be apparent to one of ordinary skill in the art. Accordingly, the present invention is not limited to the embodiments described above or depicted in the drawings, and various embodiments and modifications can be made without departing from the scope of the invention.

We claim:

1. A system for generating a profile score for an attacker, the system including:
a detection unit configured to identify one or more malicious code elements in a payload;
a weighting unit configured to associate a weighting value with each identified malicious code element; and
a classification unit configured to sum the weighting values associated with the identified malicious code elements and associate a classification with the attacker based on scored based the weighting values.

2. The system for generating a profile score for an attacker of claim 1, where the detection unit is further configured to utilize a library of potentially malicious code elements to identify one or more malicious code elements.

3. The system for generating a profile score for an attacker of claim 2, where the weighting unit is further configured to utilize weight values defined for malicious code elements from the library of potentially malicious code elements.

4. The system for generating a profile score for an attacker of claim 1, where the weighting unit is further configured to apply a model to weighting values for identified malicious code elements includes at least one of a Markov model, a model based on apparent skill, a model based on resourcing required by the malicious code, a model based on behavior patterns.

5. The system for generating a profile score for an attacker of claim 1, where the system is further configured to store at least one of attacker information corresponding to the payload, the score for the payload, the classification of the attacker, and the techniques used in the payload.

6. A method for generating a profile score for an attacker, the method including:
identifying one or more malicious code elements in a payload to create a list of malicious code elements;
associating a weighting value with each identified malicious code element in the list to create a weighted list; and
scoring the weighting list and classifying the attacker based on the score.

7. The method for generating a profile score for an attacker of claim 6, where the step of identifying one or more malicious code elements in a payload to create a list of malicious code elements includes utilizing a library of potentially malicious code elements to identify one or more malicious code elements.

8. The method for generating a profile score for an attacker of claim 7, where the step of associating a weighting value with each identified malicious code element in the list includes utilizing weight values defined for malicious code elements from the library of potentially malicious code elements.

9. The method for generating a profile score for an attacker of claim 6, where the step of associating a weighting value with each identified malicious code element in the list includes applying a model to weighting values for identified malicious code elements that includes at least one of a Markov model, a model based on apparent skill, a model based on resourcing required by the malicious code, a model based on behavior patterns.

10. The method for generating a profile score for an attacker of claim 6, where the method further includes storing at least one of attacker information corresponding to the payload, the score for the payload, the classification of the attacker, and the techniques used in the payload.

11. A persistent computer readable medium storing computer code having instructions stored therein that configure a processing device to operate to generate a profile score for an attacker as follows:
examining one or more user allocated portions of heap memory for a process image;
determining a level of entropy for the one or more user allocated portions;
if the level of entropy is below a predetermined threshold, then performing one or more secondary heuristics; and
detecting a heap spray event based on results of the one or more secondary heuristics.

12. The persistent computer readable medium of claim 11, wherein the instructions for configuring a processing device for identifying one or more malicious code elements in a payload to create a list of malicious code elements includes instructions configured to cause a processing device to utilize a library of potentially malicious code elements to identify one or more malicious code elements.

13. The persistent computer readable medium of claim 12, wherein the instructions for configuring a processing device for associating a weighting value with each identified malicious code element in the list includes instructions configured to cause a processing device to utilize weight values defined for malicious code elements from the library of potentially malicious code elements.

14. The persistent computer readable medium of claim 11, wherein the instructions for configuring a processing device for associating a weighting value with each identified malicious code element in the list includes instructions configured to cause a processing device to apply a model to weighting values for identified malicious code elements that includes at least one of a Markov model, a model based on apparent skill, a model based on resourcing required by the malicious code, a model based on behavior patterns.

15. The persistent computer readable medium of claim 11, where the medium further includes instructions for configuring a processing device for storing at least one of attacker information corresponding to the payload, the score for the payload, the classification of the attacker, and the techniques used in the payload.
